(19) United States
(12) Patent Application Publication
(10) Pub. No.: US 2026/0099538 A1
(43) Pub. Date: Apr. 9, 2026

(54) AI-Integrated Digital Legacy and Life Story Preservation Platform

(71) Applicant: Robert John Fox, Escondido, CA (US)

(72) Inventor: Robert John Fox, Escondido, CA (US)

(21) Appl. No.: 19/415,793

(22) Filed: Dec. 11, 2025

Related U.S. Application Data
(60) Provisional application No. 63/900,788, filed on Oct. 17, 2025.

(51) Int. Cl. G06F 16/438; G06F 16/955; G06F 21/60; G06F 21/78; G10L 13/027

(52) U.S. Cl. CPC G06F 16/4393; G06F 16/9554; G06F 21/602; G06F 21/78; G10L 13/027

(57) ABSTRACT

The present invention relates to an AI-integrated cross-platform digital legacy preservation platform configured to record, preserve and transmit personal stories and memories through artificial intelligence-assisted storytelling and secure posthumous communication. The platform integrates multiple modules including user registration, AI-driven biography generation, executor-managed legacy control, family tree visualization, synchronized photo albums, multilingual interface and QR-linked memorial access. The platform enables users to chronologically document their lives through videos, photos and text, while allowing designated executors to manage legacy release after death verification. The system further supports CRM synchronization, sales management and personalized digital avatars for enhanced emotional interaction. The invention offers significant advantages in ensuring data integrity, emotional continuity and accessibility across generations. The scope of the invention extends to personal, familial and institutional applications establishing a unified and secure ecosystem for long-term digital memory preservation and interactive legacy sharing.

### CROSS-REFERENCE TO RELATED APPLICATION

This disclosure claims the benefit of the priority of U.S. Provisional Ser. No. 63/900,788 entitled “Your Personal Stories.com” and filed on Oct. 17, 2025. The above-identified application is incorporated herein by reference in its entirety.

### TECHNICAL FIELD

The present invention relates to the field of digital legacy preservation system and, more specifically to an AI-integrated platform that enable users to chronologically record, archive and share personalized life stories, family connections and posthumous communications through multimedia and interactive interfaces.

### BACKGROUND

The background description includes information that may be useful in understanding the present invention. It is not an admission that any of the information provided herein is prior art or relevant to the presently claimed invention, or that any publication specifically or implicitly referenced is prior art.

Traditionally, the preservation of personal histories, memories and legacies has relied heavily on written journals, photo albums and in more recent decades, scattered digital media stored across various devices and platforms. For generations, storytelling and oral histories served as the primary method for families to pass down experiences, wisdom, and emotions. Parents and grandparents would recount their life stories to their children or gather around family events to share anecdotes of the past. However, in the digital era where people's lives are increasingly captured in fragments through social media posts, photos and short video clips there remains a significant disconnect in how these memories are preserved, organized and meaningfully shared across generations. The traditional means of preserving one's life story have become inadequate, inconsistent and fragmented in a fast-paced, technology-driven world.

Furthermore, when individuals pass away much of their emotional legacy i.e. words of encouragement, family values and deeply personal reflections often disappear with them. Despite the vast availability of digital storage and recording technology, most people never create an organized, chronological record of their lives. This leads to a significant emotional gap for families left behind who may long for continued connection or comforting messages from loved ones who have passed. Conventional methods of memory preservation such as printed photo albums or written memoirs, lack interactivity, personalization and accessibility. They are often static, deteriorate over time and fail to capture the authenticity and emotional tone of the person's voice and presence.

With the rise of smartphones and social media, people have accumulated thousands of photos and short videos. Yet, the memories are often lost within the chaos of digital clutter stored in inaccessible folders, old devices or forgotten cloud drives. Families rarely have an organized means to view, curate or share the memories in a coherent way that tells a person's life story from beginning to end. Additionally, traditional digital archives lack the emotional depth of personal storytelling, leaving behind fragmented data rather than a holistic, meaningful biography. This disorganization combined with the transient nature of online content, creates a pressing need for a secure, structured and emotionally resonant platform where individuals can chronologically archive their life's journey in a permanent and interactive way.

In the context of end-of-life planning, there exists another critical gap. While legal documents like wills and estate plans help distribute material assets, they fail to address the emotional and relational aspects of a person's legacy. There is no formal system that allows individuals to leave behind heartfelt, pre-recorded video messages that can be delivered posthumously to loved ones. This creates an emotional void for families who wish they could hear a loved one's voice one more time reassuring them, celebrating their achievements or simply expressing love. The lack of an organized, secure mechanism to store and release such personal messages, triggered by an authenticated executor upon confirmation of death, represents a missed opportunity for emotional continuity and healing within families.

Additionally, family lineage and history which were once preserved through family trees and oral traditions are now fading in modern society. Many families lose track of extended relatives, ancestral roots and family milestones. Current genealogy and family tree tools, while useful for data mapping do not integrate emotional storytelling or interactive communication among family members. They fail to create a living, breathing legacy that grows over time. The absence of a digital ecosystem that combines family connection, emotional storytelling and technological interactivity has left a void in how families remember, connect and celebrate their shared heritage.

In view of the above challenges, there is a pressing need for a holistic, technologically advanced yet emotionally sensitive platform that enables users to preserve their personal histories, communicate with loved ones beyond their lifetime and maintain interactive family connections. Such a platform should integrate traditional memory preservation with modern tools such as AI-generated biography videos, executor-triggered posthumous communications, dynamic family trees and digital photo albums.

### SUMMARY

The present invention relates to an AI-integrated digital legacy and life story preservation platform configured to chronologically document, preserve and share an individual's life experiences through video storytelling and interactive family connections. The platform is accessible via web and mobile applications (iOS and Android), enables users to create and archive personal video memories beginning from childhood through key life milestones. The videos form a dynamic life archive that can continue to evolve with time. A unique executor capability allows a designated individual to manage a user's account after their passing, authenticating the event through verified documentation and triggering the release of pre-recorded messages or final videos to intended recipients, ensuring enduring emotional connections beyond life. The invention offers several advantages that include the ability to permanently preserve personal and family legacies in an organized, multimedia form; emotional continuity through posthumous video messaging; AI-enhanced biographical storytelling that humanizes digital memorials and an interconnected family tree that unites generations. The invention addresses the problem of unshared digital memories by offering a secure, user-friendly and emotionally intelligent platform that transforms how individuals record and relive their life stories ensuring that personal histories are remembered, shared and cherished for generations to come.

In an embodiment of the present invention, the invention discloses a cross-platform digital legacy preservation platform. The platform comprising a user interface module configured for user registration, profile creation, video recording, uploading, categorization by life events and subscription management, a cloud-based data management module configured to securely store, organize and archive multimedia content and user information. The platform also includes an AI biography builder configured to generate automated life story videos using uploaded media, textual inputs and AI voice synthesis, a legacy management module configured to enable recording and delivery of private posthumous messages, executor assignment, death verification and automatic account freezing upon confirmation and a family tree builder configured to create, visualize and link family relationships with multimedia integration and invitation functions. In addition, a photo album module is configured to synchronize, curate and display personal photo collections with customizable privacy settings. A multi-language interface module is configured to provide user-selectable language options and enable multilingual content tagging, searching and labelling for improved accessibility and discovery. A QR code generator is configured to create unique scannable codes linked to user profiles or memorial pages. The platform provides a unified digital environment for recording, preserving and transmitting personal legacies through AI-assisted storytelling, executor-controlled message delivery and interactive family connectivity.

In the embodiment, the photo album module may include an interactive photo album which is configured to allow creators or users of the photo album not only to share their photo album with other users, but also invite other people to add photos, and videos to the album. In an exemplary embodiment, when somebody attends a recent wedding and creates a photo album within the photo album, the photo album may be labeled with the wedding's name on it. The creator of that photo album can invite other attendees of the wedding to upload their photos to the album as well. This creates an interactive archive of the event that took place. This could be used for any occasion or event.

In one of the embodiments of the present invention, the user interface is further configured to manage subscription tiers including free, standard and premium plans, each defining video upload limits, storage capacity and access to premium AI features.

In one of the embodiments of the present invention, the cloud-based data management module employs encrypted storage protocols and redundant backup servers to ensure data security, user privacy and long-term preservation of archived content.

In one of the embodiments of the present invention, the cloud-based data management module employs encrypted storage protocols and redundant backup servers to ensure data security, user privacy and long-term preservation of archived content.

In one of the embodiments of the present invention, the AI biography builder integrates image recognition, voice synthesis and text-to-video generation tools to automatically compile life story videos with personalized narration and visual transitions.

In one of the embodiments of the present invention, the AI biography builder utilizes third-party AI voice and animation APIs to recreate realistic likenesses of deceased individuals for memorial representation.

In one of the embodiments of the present invention, the legacy management module is operable by an assigned executor who verifies the user's death by uploading a digital death certificate, triggering posthumous delivery of pre-recorded messages to designated recipients.

In one of the embodiments of the present invention, the family tree builder comprises an interactive graphical interface enabling users to add family members, assign relational roles, attach photos and biographical data and link existing platform accounts.

In one of the embodiments of the present invention, the family tree builder enables communication among linked profiles and generates invitations for relatives to join the digital network.

In one of the embodiments of the present invention, the photo album module enables automated synchronization with a mobile device gallery, creation of categorized photo albums and selection of public or private viewing modes.

In one of the embodiments of the present invention, the multi-language interface module supports dynamic translation of the user interface and metadata into multiple languages including English, Spanish, French or any other similar language.

In one of the embodiments of the present invention, the QR code generator produces downloadable and printable QR codes that when scanned provide direct access to a user's public biography page or memorial profile.

In one of the embodiments of the present invention, the QR code is configured for placement on physical memorials, plaques or gravestones to enable digital access to the preserved legacy content of the deceased user.

In one of the embodiments of the present invention, the platform further includes a sales agent interface module configured to register sales agents, track customer enrollments and renewals, calculate tier-based commissions and generate periodic performance and revenue reports.

In one of the embodiments of the present invention, the platform also utilizes a customer relationship management (CRM) module configured to synchronize with external CRM systems for managing client leads, pipelines and agent activities.

In another embodiment of the present invention, the invention discloses a method for operating a cross-platform digital legacy preservation platform. The method comprising registering a user through a web or mobile interface including creating a personal profile, selecting a subscription tier and assigning a designated executor. Uploading and organizing multimedia content including videos, photos and text into a secure cloud archive and generating AI-driven biographical videos by processing user-provided media and textual inputs using artificial intelligence tools to create synthesized narratives with selectable voice or digital avatar representations. The method also includes appointing and managing an executor authorized to verify the user's death by uploading a death certificate upon which the platform freezes the user account and automatically releases pre-recorded posthumous messages and videos to specified recipients. The method also constructs an interactive family tree linking the user to relatives and friends and synchronizes photo albums from user devices to create curated digital galleries with adjustable privacy controls and continuous display functionality. In addition, a unique scannable QR code is generated corresponding to the user's digital memorial page.

In one of the embodiments of the present invention, uploading and organizing of multimedia content includes categorizing content according to life events such as childhood, education, marriage and career milestones.

In one of the embodiments of the present invention, the platform supports multilingual interfaces allowing users to create, tag and search content in multiple languages.

In one of the embodiments of the present invention, the synchronized photo albums are automatically updated from user devices or cloud storage and include privacy settings for public or restricted viewing.

For further clarification of the features and other embodiments of the present invention, a more particular description is provided that will further explain the features and advantage of the invention with the illustration or the drawings. As will be appreciated, other embodiments of the present invention are possible utilizing, alone or more of the features set forth above or described in detail below.

### BRIEF DESCRIPTION OF THE DRAWINGS

FIG. 1 illustrates a block diagram of an AI-integrated cross-platform digital legacy preservation platform, in accordance with embodiments of the present invention disclosed herein.

FIG. 2 illustrates a flowchart of the method for operating an AI-integrated cross-platform digital legacy preservation platform, in accordance with embodiments of the present invention disclosed herein.

FIG. 3 illustrates a perspective view of an artificial intelligence (AI) and machine learning integration architecture, in accordance with embodiments of the present invention disclosed herein.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION

References will now be made in detail to the presently preferred embodiments of the invention, examples of which are illustrated in the accompanying drawings. Throughout the following detailed description, the same reference numerals refer to the same elements in all figures.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In the following description, reference will be made to the accompanying drawings, in which comparable functional elements are designated with like numerals. The aforementioned accompanying drawings show by way of illustration and not by way of limitation, specific aspects and implementations consistent with principles of this disclosure These implementations are described in sufficient detail to enable those skilled in the art to practice the disclosure, and it is to be understood that other implementations may be made without departing from the scope and spirit of the disclosure. The following detail description is, therefore, not intended as an extensive overview, and as such, concept may be simplified in the interests of clarity and brevity. All cited documents are incorporated by reference.

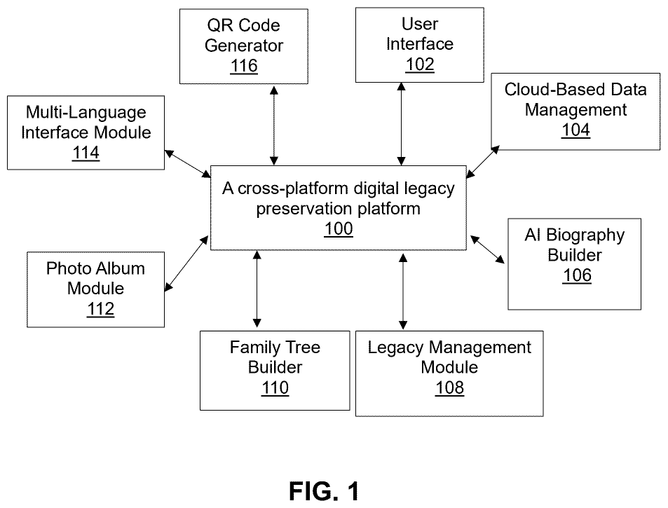

According to an embodiment of the present invention, the invention discloses an AI-integrated cross-platform digital legacy preservation platform as shown by in FIG. 1. The platform 100 integrates web, iOS and Android applications and comprises multiple functional modules that collectively facilitate user registration, content creation, AI-assisted storytelling, executor-based posthumous message delivery and interactive family connectivity. The platform comprises a user interface module 102 configured for user registration, profile creation, subscription management, video recording, uploading and categorization by life events. Through this module 102, users can chronologically record their life experiences such as earliest childhood memories, first day of school, marriage, career achievements or personal reflections. Each video is automatically organized into thematic categories and tagged for easy retrieval. Subscription tiers include Free, Standard and Premium plans, each defining storage capacity, video duration limits and access to enhanced AI features. Premium members enjoy unlimited uploads, access to advanced AI biography tools and personalized branding options. The platform 100 further includes a cloud-based data management module 104 that securely stores, organizes and archives multimedia content and user information. The cloud-based management module 104 employs encrypted storage protocols, multi-factor authentication and redundant backup servers to ensure data integrity, security and long-term preservation. Scalable architecture using Supabase, AWS and Vercel supports 5,000-20,000 concurrent users and guarantees reliable access across global networks. An integral component of the platform is an AI biography builder 106 configured to generate automated life story videos by integrating uploaded media, textual information and AI-driven voice synthesis. The AI biography builder 106 supports two distinct modes which includes a guided mode where users upload photos and life details through an interactive GUI which then compiles a narrated video with visual transitions and an advanced mode that recreates a realistic likeness of the deceased using AI voice and animation APIs such as Voice. AI, Eleven Labs, Hume AI, Murf AI or similar systems. The AI biography builder 106 allows for dynamic storytelling and life representation, preserving a person's voice and persona in a lasting digital form. The platform 100 also includes a legacy management module 108 that enables recording and delivery of private posthumous messages. Each account holder can designate an Account Executor who has the authority to verify the account holder's death by uploading an authenticated digital death certificate. Upon verification, the platform 100 automatically freezes the deceased user's account, transitions it to an archival state and triggers the release of pre-recorded videos and messages to designated recipients. For example, a grandparent may pre-record a video message for a grandchild expressing love and pride which would be delivered only after their passing. The legacy management module 108 ensures that final communications are handled with authenticity, privacy and emotional continuity. The family tree builder 110 provides an interactive and visual representation of familial and social relationships. Users can add parents, siblings, children, grandchildren, nieces, nephews or friends and attach photos and personal data to each node. The family tree allows for navigation between linked profiles and includes built-in chat and sharing features to enhance family engagement. This component also connects to the CRM module, providing potential referral insights for platform expansion. The photo album module 112 enables automated synchronization with a mobile device's gallery, allowing users to curate personal photos into categorized albums viewable on any connected display device. The platform 100 transforms ordinary tablets into digital photo frames capable of displaying cycling memories, effectively bridging the gap between stored and shared memories. Users can control privacy levels by marking albums as public or private. The multi-language interface module 114 offers users the ability to navigate and interact with the platform in various languages including English, Spanish, and French. It supports multilingual tagging, search and content labeling, allowing seamless accessibility for users worldwide. Video titles and descriptions can be translated dynamically, promoting cultural inclusivity and user-friendly engagement. The platform 100 integrates a QR code generator 116 that creates unique scannable codes linked to individual user profiles or memorial pages. The QR code can be downloaded, printed or laminated for placement on physical memorials, headstones or plaques. When scanned, the code directs the viewer to the user's digital biography or memorial page, thereby bridging the physical and digital realms of remembrance.

In one of the embodiments of the present invention, the invention discloses an executor portal that provides a secure, permission-controlled environment through which the designated executor can manage account verification, upload necessary documentation, and oversee the delivery of final messages. Once death verification is confirmed, the platform 100 transitions to read-only mode, preventing further modifications to the user's data while preserving the integrity of their digital legacy. The platform also supports white-label configurations, enabling resellers and institutional partners to rebrand the platform with custom logos, domains and user interfaces. Each white-label instance includes independent administrative dashboards, sales management tools and revenue tracking features.

In one of the embodiments of the present invention, the invention also includes a sales agent interface module that is configured to register sales agents, track customer enrolments and renewals, calculate tier-based commissions and generate periodic performance and revenue reports. The platform also utilizes a customer relationship management (CRM) module which is configured to synchronize with external CRM systems for managing client leads, pipelines and agent activities.

In one of the embodiments of the present invention, the invention discloses an enterprise-grade, multi-tenant digital legacy preservation platform configured to enable secure video archiving, AI-powered digital avatar creation, family tree generation, posthumous communication through executor-managed delivery and white-label deployment for enterprise partners. The platform adopts a modular monolithic architecture with defined service boundaries, enabling future migration to microservices. It delivers sub-200 ms API response times, under-500 ms video playback initiation, horizontal scalability for 5,000-20,000 active users, multi-layered security with encryption, RBAC and audit logging and 99.9% uptime through redundant infrastructure. The architecture complies with GDPR, CCPA and HIPAA standards with data residency support. The system utilizes Next.js 14+, React 18+ and TypeScript for frontend development; Flutter for mobile applications; Node. js with Express. js and TypeScript for backend; PostgreSQL 15+ with read replicas; Redis Cluster for caching; Cloudflare R2 or AWS S3 for storage; Cloudflare CDN for global delivery and Mux for video processing. AI functionalities are powered by OpenAI GPT-4 for narrative generation, D-ID for avatar rendering and ElevenLabs or any other similar client for voice synthesis.

In one of the embodiments of the present invention, the platform implements a series of key architectural decisions that optimize performance, scalability and maintainability. The platform adopts a modular monolithic architecture for initial deployment selected over microservices to achieve faster development and deployment cycles, reduced operational complexity, simplified debugging and testing and lower infrastructure costs. The architecture defines clear module boundaries that facilitate a future migration to microservices when daily active users exceed approximately 20,000 or the development team surpasses fifteen members. The platform utilizes PostgreSQL as the primary database engine in preference to NoSQL system. The choice provides strong ACID compliance for transactional reliability, robust query capabilities for complex relationships such as family tree mapping and commission calculations and integrated JSON/JSONB support for flexible schema design. PostgreSQL further offers row-level security (RLS) for tenant isolation, a mature ecosystem and proven scalability suited to the target user base. For multimedia management, the platform employs a centralized video processing architecture utilizing a managed service such as Mux. The configuration reduces operational overhead, provides enterprise-grade CDN integration, enables automatic adaptive bitrate encoding and delivers comprehensive analytics and predictable scaling characteristics, allowing development resources to remain focused on core business functionality. To support multi-tenancy, the platform adopts a hybrid data isolation strategy comprising schema-based segregation for premium tenants and row-level security for standard tenants. The approach balances security isolation with operational efficiency, supports tiered white-label offerings provides a scalable upgrade path for expanding tenants and maintains a unified codebase that simplifies cross-tenant analytics and administrative management.

In one of the embodiments of the present invention, the platform is configured with comprehensive compliance, privacy and security frameworks ensuring adherence to global regulatory standards. The platform implements GDPR-compliant data processing and storage incorporating the right to erasure for complete user data deletion and data portability functions enabling users to export their stored information in standardized formats. The architecture follows a privacy-by-design principle, embedding user privacy controls into all core functionalities and includes a consent management system for obtaining, tracking and managing user permissions across data usage and communication preferences. The platform further integrates a content moderation framework comprising automated content scanning for detection of inappropriate or policy-violating material, a manual review queue for administrator verification of flagged content and a DMCA-compliant takedown process for copyright-protected materials. Additionally, age verification protocols are implemented for access to sensitive or restricted content categories. For financial transactions, the platform complies with PCI DSS Level 1 standards through integration with Stripe's payment infrastructure, ensuring secure handling of payment credentials and transactional data. The platform incorporates anti-money laundering (AML) and know your customer (KYC) verification mechanisms for high-value transactions, maintains transaction audit trails for regulatory traceability and supports multi-party payment compliance via stripe connect to facilitate commission distributions and partner settlements within a controlled financial ecosystem.

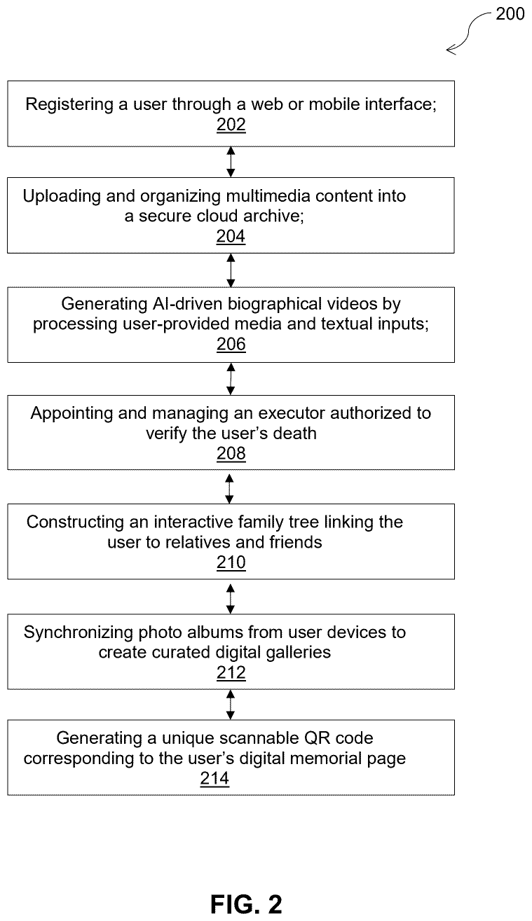

In another embodiment of the present invention, the invention discloses a method for operating an AI-integrated cross-platform digital legacy preservation platform as shown by FIG. 2. The method 200 begins with registering a user through a web or mobile interface, the user creates a personal profile by entering biographical information, contact details and selecting a desired subscription tier as shown by step 202. The platform may offer multiple subscription levels such as Free, Standard and Premium each defining storage limits, AI access privileges and additional customization features. During registration, the user also assigns a designated executor who is authorized to manage the account upon the user's death. In the embodiment, in step 204, the method 200 includes uploading and organizing multimedia content into a secure, cloud-based archive. The user can upload videos, photos, audio recordings and textual materials that together form a chronological digital record of their life. In one implementation, the step 204 further includes categorizing the uploaded content according to life events such as childhood, education, first job, marriage, family milestones, achievements and retirement. Each media entry is time-stamped, labeled and indexed to allow for seamless retrieval and playback. In the embodiment, step 206 discloses uploading the data which is processed through an AI-driven biographical video generation engine which utilizes artificial intelligence to synthesize multimedia content into cohesive narrative sequences. The platform employs speech synthesis, natural language processing and facial animation tools to create personalized biographical videos with selectable voice tones, language options and digital avatar representations. The AI integrates the user's photos, videos and textual reflections to construct a lifelike, emotionally resonant biography that evolves as additional data is uploaded. In step 208, the method 200 further includes appointing and managing the executor. The designated executor holds administrative authority to verify the user's death by uploading a government-issued or digitally authenticated death certificate. Upon verification, the platform automatically freezes the user's account, transitions it into an archival state and initiates the controlled release of pre-recorded posthumous messages, videos or letters to recipients predetermined by the user. This ensures secure and verified transmission of final communications in accordance with the user's intent. In the embodiment, Step 210 discloses the platform facilitates constructing an interactive family tree, linking the user to relatives, descendants and friends. Each family member's profile can include biographical information, photos, and videos forming a connected digital lineage. This structure allows users to explore relationships across generations and view interlinked multimedia memories, fostering an enduring digital heritage ecosystem. The method 200 further includes synchronizing photo albums from the user's device gallery or third-party cloud storage platforms to create curated digital galleries as shown by step 212. The platform automatically updates the albums as new images are added to the user's device, ensuring real-time reflection of personal milestones. Albums can be assigned privacy levels such as public, private or restricted to family members and may include continuous display or slideshow mode suitable for connected digital photo frames or memorial screens. The step 214 discloses generation of a unique, scannable QR code corresponding to each user's digital memorial page. The QR code can be downloaded or printed and placed on physical memorial objects such as gravestones or plaques. When scanned, the code directs viewers to the individual's memorial profile where they can access their biography, uploaded media and recorded messages, thereby bridging the physical and digital spheres of remembrance.

In one of the embodiments of the present invention, the method 200 further includes a multilingual interface capability allowing users to create, tag and search content in multiple languages. The platform automatically translates titles, captions, and metadata, ensuring inclusive accessibility for users from diverse linguistic backgrounds.

In one of the embodiments of the present invention, the AI-integrated cross-platform digital legacy preservation platform further comprises a multilayer technical architecture designed to ensure scalability, reliability, data security and performance efficiency across all operational environments. The platform architecture is structured into distinct layers including a client layer, edge and CDN layer, application layer, background processing layer and data layer, each configured to perform specific functions that collectively enable seamless operation of the platform. The client layer includes a web application, a mobile application and an administrative portal. The web application, implemented using Next.js 14+ with App Router and React Server Components provides the primary user interface for desktop and mobile browsers. It supports server-side rendering for SEO optimization, static site generation for marketing pages, client-side rendering for interactivity and progressive web app functionality. Authentication is handled using JWT tokens stored in httpOnly cookies with state management facilitated through React Context and TanStack Query. Real-time capabilities including avatar chat and notifications are achieved using WebSocket connections. The mobile application, developed using Flutter 3.0+ with Dart, delivers native iOS and Android functionality. It supports offline-first operation through an integrated SQLite database, background video upload, push notifications via Firebase Cloud Messaging (FCM) and biometric authentication. API communication is handled via RESTful endpoints with retry and offline queue logic, and state management is achieved using Riverpod. The admin portal also implemented in Next. js, provides administrative access with role-based access control (RBAC). It includes modules for user and content moderation, analytics, white-label tenant management, commission tracking, payout management, and audit log review. The edge and CDN layer employs Cloudflare CDN for global content delivery, caching and DDOS protection. With over 275 edge locations worldwide, it manages SSL/TLS certificates, enforces HTTP/3 and QUIC protocols and supports both protection and rate limiting. The caching strategy includes 30-day retention for static assets, 5-minute caching for API responses, 7-day caching for video thumbnails and 1-day caching for user avatars with invalidation upon update. A NGINX-based load balancer performs SSL termination, WebSocket upgrades and automatic failover using a least-connections algorithm. A web application firewall (WAF) protects the system from common web-based attacks including SQL injection, cross-site scripting (XSS), and excessive request flooding. The application layer consists of Node.js and Express-based API servers configured in a modular monolithic architecture. Core modules include authentication, user management, video processing, AI avatar creation, personality assessment, family tree management, subscriptions, white-label tenant operations, sales CRM and executor verification. The system includes centralized error handling, structured logging via Winston, and validation using Joi schemas. The platform also incorporates dedicated Next.js SSR servers for dynamic page rendering and image optimization. A centralized authentication service provides multi-factor authentication, OAuth integration, and session management through JWT and refresh tokens. The background processing layer employs a Redis-backed Bull Queue system for asynchronous job handling, supporting task prioritization, retries and delayed scheduling. Dedicated worker processes include a video processing worker (for transcoding, metadata extraction, and CDN upload), an AI avatar worker (for personality processing, avatar generation, and voice synthesis), an email worker (for transactional, notification, and marketing emails), and an analytics worker (for metric aggregation and dashboard preparation). The data layer employs PostgreSQL as the primary relational database, configured with a master-write and replica-read architecture supporting streaming replication and automatic failover. Connection pooling is handled using PgBouncer with continuous archiving and point-in-time recovery for backup. Redis is implemented as a three-node cluster for caching, session storage, job queue management, and rate limiting. The combination of PostgreSQL and Redis ensures high performance, consistency, and real-time responsiveness across the platform.

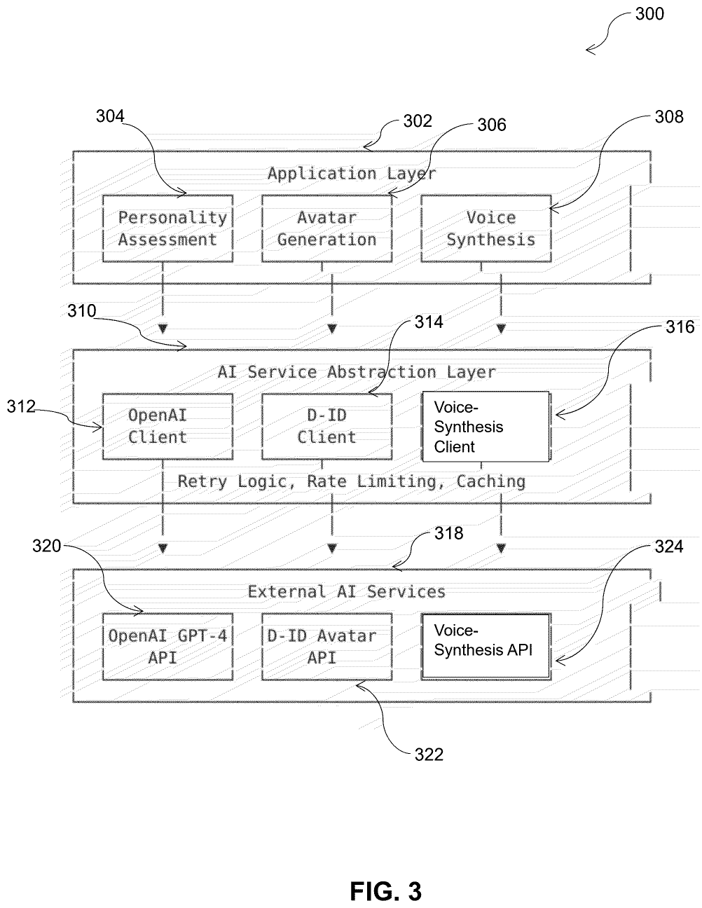

Referring to FIG. 3, the invention discloses an artificial intelligence (AI) and machine learning integration architecture. The architecture 300 is hierarchically organized into three principal layers namely an Application Layer, an AI Service Abstraction Layer, and an External AI Services Layer, each configured to cooperate in enabling intelligent personality modeling, avatar generation, and voice synthesis functionalities. In the embodiment, the Application Layer 302 includes a plurality of AI-driven modules such as a Personality Assessment module 304, an Avatar Generation module 306 and a Voice Synthesis module 308. The Personality Assessment module 304 is configured to process user-provided data such as video content, textual input and interaction history to generate an individualized psychological or emotional profile that guides avatar behavior and tone. The Avatar Generation module 306 is configured to create dynamic and visually realistic digital avatars by utilizing AI-based facial animation and rendering APIs. The Voice Synthesis module 308 generates corresponding synthetic speech, replicating the user's tone, timbre and emotional inflection for authentic audiovisual storytelling. The AI Service Abstraction Layer 310 operates as an intermediary framework between the application modules and third-party AI service providers. This layer 310 comprises dedicated API clients including an OpenAI Client 312, a D-ID Client 314 and an Voice-synthesis Client 316, each encapsulated within a unified abstraction layer incorporating retry logic, rate limiting, and response caching mechanisms. The abstraction layer 310 ensures service reliability, load balancing and fault tolerance while enabling the seamless interchangeability of AI providers without modifying the core business logic of the platform. The External AI Services Layer 318 interfaces with external APIs such as the OpenAI GPT-4 API 320, the D-ID Avatar API 322 and the Voice synthesis API 324. Examples of compatible voice-synthesis providers include but are not limited to ElevenLabs, Murf AI, Hume AI, Voice.AI or other similar neural voice generation technologies. The services collectively power the high-level AI capabilities of the platform. Specifically, the OpenAI GPT-4 API performs advanced natural language processing and contextual understanding for narrative generation; the D-ID Avatar API performs facial animation and video rendering of digital likenesses and the Voice API utilizes ElevenLabs or any other similar client for lifelike speech with customizable emotional tone.

In an exemplary embodiment of the present invention, the platform implements an automated video upload and processing architecture comprising sequential phases of upload initialization, direct upload, queue processing and notification. During initialization, a client device communicates with the API server to create a video record in a PostgreSQL database (status: “pending_upload”) and obtain a direct upload URL generated via Mux. The client then performs a direct upload to Mux or S3 using the provided URL. Upon completion, a webhook (/webhooks/mux/upload-complete) notifies the API server which enqueues a video-processing job in a background queue (e.g., Bull Queue). A worker processes the queued job by interfacing with the Mux API to transcode the video, generate thumbnails, extract metadata, and update the video status to “ready” in the database. Once processing is complete, a “video.processed” event is published to an event bus, triggering analytics tracking and user notifications via email and push message indicating that the video is ready for viewing.

In one of the embodiments of the present invention, the platform further comprises an AI avatar conversation module configured to facilitate interactive, personality-driven communication between users and their digital avatars. The AI avatar conversation module enables users, family members, or designated executors to engage in real-time dialogue with AI-generated avatars that replicate the user's personality, voice and expressive behaviour. When a user initiates a conversation through the client interface, the API server retrieves corresponding avatar data, including personality traits, voice identifiers,=and recent conversation history stored in a PostgreSQL database. The server constructs a personality-specific prompt incorporating contextual conversation history and user inputs, which is processed by an AI language model to generate a coherent text-based response. The generated textual response is transmitted to a text-to-speech engine such as ElevenLabs, MurfAI, HumeAI, Voice.AI etc, to produce a corresponding audio stream in the avatar's assigned or cloned voice. The audio file is then uploaded to a secure cloud storage system, for example, Cloudflare R2 or Amazon S3, generating a retrievable public URL. The platform further invokes an AI-driven animation service, such as D-ID to generate a synchronized video representation of the avatar speaking the audio content. Upon completion, the platform retrieves and stores the generated video URL and associates it with the ongoing conversation record. The combined output including the generated text, synthesized audio, and rendered video is stored in the database and delivered to the client device for playback through the user interface. The client application displays the avatar's animated video and plays the synchronized audio while rendering the text transcript of the conversation. The module enables lifelike interaction with the AI avatar, preserving the essence, voice and personality of the user for posthumous engagement and digital remembrance, thereby extending the capabilities of the AI-integrated legacy preservation platform.

In one of the embodiments of the present invention, a subscription payment management module is configured to facilitate secure, automated, and tier-based payment processing for user subscriptions. The subscription payment management module enables users to initiate subscription requests through the client interface which are transmitted to the API server for processing. The API server communicates with a payment gateway, such as Stripe to create a checkout session corresponding to the selected subscription tier (e.g., Free, Standard, or Premium). The session includes user-specific metadata and secure redirect URLs for successful or cancelled transactions. Upon completion of the payment process, the payment gateway transmits a webhook notification to the API server confirming the transaction. The API server verifies the webhook signature and updates the PostgreSQL database to record subscription details, including user identification, tier level, and associated transaction metadata. The platform also records entries in transaction and commission tables for financial traceability and auditing. In the embodiment where the platform operates under a white-label or reseller configuration, the subscription payment management module further calculates and distributes commission breakdowns based on pre-defined models such as revenue-share, markup, or hybrid. The platform automates fund transfers to reseller or partner accounts via the payment gateway's transfer API and logs commission data in dedicated distribution tables. The module additionally supports hierarchical commission structures, allowing sales agent incentives to be automatically computed from reseller earnings and recorded for subsequent payout. Upon successful subscription activation, the API server updates user permissions, unlocks premium platform features, and adjusts usage limits for video uploads, AI token allocation, and data storage capacity. The module also generates user notifications through email and push messaging, confirming subscription activation, payment details, and billing cycles.

In one of the embodiments of the present invention, the platform further comprises a death certificate verification and executor authentication module configured to validate a deceased user's identity, authorize an executor and automate the release of pre-recorded posthumous content. The module initiates a verification flow when an authorized executor accesses a public memorial page associated with a deceased user profile and submits a claim request through the client interface. The request includes executor identification details such as name, email, relationship to the deceased and a digitally uploaded death certificate. The API server stores the submission in the PostgreSQL database by generating executor and death verification records, each assigned an initial “pending” status. Concurrently, the platform creates an administrative review task flagged for priority verification. During the verification phase, an administrator accesses the review interface via an administrative portal to examine the uploaded death certificate. The administrator verifies critical parameters including the deceased's name, date of death, issuing authority, and cross-check government databases through integrated APIs. Upon successful validation, the administrator updates the verification status to “verified,” prompting the API server to automatically update the corresponding database entries for the executor, death verification record, and user account status to “deceased verified.” All verification actions are logged in the platform audit trail for transparency and compliance. Once the death verification is confirmed, the module generates executor authentication credentials with limited privileges defined by a specialized “executor” role. The permissions include read-only access to the deceased user's account and the authority to initiate delivery of final recorded messages. The API server identifies all stored video messages designated as final messages, retrieves associated recipient lists and transmits the content via the platform's secure email delivery service. Each video message is accompanied by a time-limited access link (e.g., 90-day expiration) to ensure privacy and controlled access. The database is subsequently updated to mark messages as “delivered” and record corresponding timestamps. Upon completion of message delivery, the platform notifies the verified executor through a confirmation email detailing the number of messages successfully dispatched. The analytics module concurrently logs final message delivery metrics and updates audit records to maintain comprehensive operational traceability. The death certificate verification and executor authentication module thereby ensures ethical, verified and secure posthumous content delivery within the digital legacy preservation platform, maintaining both authenticity and emotional continuity for intended recipient.

In one of the embodiments of the present invention, the disclosed AI-integrated cross-platform digital legacy preservation platform constitutes a technological advantage that provides specific and substantial technical improvements over conventional digital memorial or content storage systems, thereby transcending the realm of abstract ideas or business processes. The invention implements a distributed cloud architecture integrating modules for AI-based biography generation, avatar-driven conversational interaction, automated subscription payment handling and verified posthumous message delivery all executed through coordinated application programming interfaces (APIs) used by the platform having encrypted data pipelines and asynchronous message queues. Unlike conventional manual legacy platforms that rely on human curation or static data entry, the disclosed platform autonomously manages multimedia processing, identity verification, voice synthesis and personalized content rendering through technical modules configured to interface with machine learning and media generation frameworks. The architecture employs load-balanced servers, secured REST APIs and event-driven background workers that perform transcoding, metadata extraction and encrypted storage operations. These functions are executed automatically without human intervention, resulting in measurable improvements in system reliability, latency reduction and data integrity. Accordingly, the present invention includes technical enhancements that include: real-time integration of multiple AI models for natural language generation and synthetic media rendering, optimized cloud-based orchestration for concurrent multimedia processing and secure delivery, an automated verification workflow ensuring authenticated executor-based message release and dynamic data caching and queue management improving resource utilization and scalability. These collective advancements demonstrate a concrete application of computing technologies that materially improve digital data management systems and human-computer interaction efficiency. Further, the areas of application of the invention extend across multiple technological domains including but not limited to Digital legacy and memorial platforms providing authenticated archival and posthumous communication capabilities; AI-driven media generation systems, supporting avatar-based storytelling and personalized video synthesis; Secure cloud content management, enabling encrypted multimedia storage and access control; Human-computer interaction systems, delivering natural language and audiovisual engagement through personalized AI avatars; and Enterprise-grade subscription ecosystems, employing automated billing, analytics, and data-driven personalization across distributed servers.

It should be understood that the examples provided herein are intended only for purposes of illustration and any number of other implementations is also contemplated. Additionally, the referenced examples (including the described rules and/or other techniques) can be combined in any number of ways.

Although an overview of the inventive subject matter has been described with reference to specific example implementations, various modifications and changes can be made to those implementations without departing from the broader scopes of implementation of the present disclosure. Such implementation of the inventive subject matter can be referred to herein, individually or collectively, by the term “invention” merely for convenience without intending to voluntarily limit the scope of this application to any single disclosure or inventive concept if more than one is, in fact is disclosed.

The implementations illustrated herein are described in sufficient detail to enable those skilled in the art to practice the teachings disclosed. Other implementations can be used and derived therefrom, such that structural substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources or structures described herein as a single instance. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A cross-platform digital legacy preservation platform, the platform comprising:
a user interface module configured for user registration, profile creation, video recording, uploading, categorization by life events and subscription management;
a cloud-based data management module configured to securely store, organize and archive multimedia content and user information;
an AI biography builder configured to generate automated life story videos using uploaded media, textual inputs and AI voice synthesis;
a legacy management module configured to enable recording and delivery of private posthumous messages, executor assignment, death verification and automatic account freezing upon confirmation;
a family tree builder configured to create, visualize and link family relationships with multimedia integration and invitation functions;
a photo album module configured to synchronize, curate and display personal photo collections with customizable privacy settings;
a multi-language interface module configured to provide user-selectable language options and enable multilingual content tagging, searching and labelling for improved accessibility and discovery;
a QR code generator configured to create unique scannable codes linked to user profiles or memorial pages;
wherein the platform provides a unified digital environment for recording, preserving and transmitting personal legacies through AI-assisted storytelling, executor-controlled message delivery and interactive family connectivity.

2. The platform as claimed in claim 1, wherein the user interface is further configured to manage subscription tiers including free, standard and premium plans, each defining video upload limits, storage capacity and access to premium AI features.

3. The platform as claimed in claim 1, wherein the cloud-based data management module employs encrypted storage protocols and redundant backup servers to ensure data security, user privacy, and long-term preservation of archived content.

4. The platform as claimed in claim 1, wherein the cloud-based data management module employs encrypted storage protocols and redundant backup servers to ensure data security, user privacy and long-term preservation of archived content.

5. The platform as claimed in claim 1, wherein the AI biography builder integrates image recognition, voice synthesis and text-to-video generation tools to automatically compile life story videos with personalized narration and visual transitions.

6. The platform as claimed in claim 1, wherein the AI biography builder utilizes third-party AI voice and animation APIs to recreate realistic likenesses of deceased individuals for memorial representation.

7. The platform as claimed in claim 1, wherein the legacy management module is operable by an assigned executor who verifies the user's death by uploading a digital death certificate, triggering posthumous delivery of pre-recorded messages to designated recipients.

8. The platform as claimed in claim 1, wherein the family tree builder comprises an interactive graphical interface enabling users to add family members, assign relational roles, attach photos and biographical data and link existing platform accounts.

9. The platform as claimed in claim 1, wherein the family tree builder enables communication among linked profiles and generates invitations for relatives to join the digital network.

10. The platform as claimed in claim 1, wherein the photo album module enables automated synchronization with a mobile device gallery, creation of categorized photo albums, and selection of public or private viewing modes.

11. The platform as claimed in claim 1, wherein the multi-language interface module supports dynamic translation of the user interface and metadata into multiple languages including English, Spanish, French or any other similar language.

12. The platform as claimed in claim 1, wherein the QR code generator produces downloadable and printable QR codes that, when scanned, provide direct access to a user's public biography page or memorial profile.

13. The platform as claimed in claim 1, wherein the QR code is configured for placement on physical memorials, plaques, or gravestones to enable digital access to the preserved legacy content of the deceased user.

14. The platform as claimed in claim 1, wherein the platform further includes a sales agent interface module configured to register sales agents, track customer enrollments and renewals, calculate tier-based commissions and generate periodic performance and revenue reports.

15. The platform as claimed in claim 1, wherein the platform also utilizes a customer relationship management (CRM) module configured to synchronize with external CRM systems for managing client leads, pipelines and agent activities.

16. A method for operating a cross-platform digital legacy preservation platform, the method comprising:
registering a user through a web or mobile interface including creating a personal profile, selecting a subscription tier and assigning a designated executor;
uploading and organizing multimedia content including videos, photos, and text into a secure cloud archive;
generating AI-driven biographical videos by processing user-provided media and textual inputs using artificial intelligence tools to create synthesized narratives with selectable voice or digital avatar representations;
appointing and managing an executor authorized to verify the user's death by uploading a death certificate upon which the platform freezes the user account and automatically releases pre-recorded posthumous messages and videos to specified recipients;
constructing an interactive family tree linking the user to relatives and friends;
synchronizing photo albums from user devices to create curated digital galleries with adjustable privacy controls and continuous display functionality;
generating a unique scannable QR code corresponding to the user's digital memorial page.

17. The method as claimed in claim 16, wherein uploading and organizing of multimedia content includes categorizing content according to life events such as childhood, education, marriage and career milestones.

18. The method as claimed in claim 16, wherein the platform supports multilingual interfaces allowing users to create, tag and search content in multiple languages.

19. The method as claimed in claim 16, wherein the synchronized photo albums are automatically updated from user devices or cloud storage and include privacy settings for public or restricted viewing.
